(19) United States
(12) Patent Application Publication
(10) Pub. No.: US 2013/0336204 A1
(43) Pub. Date: Dec. 19, 2013

(54) CONTROL METHOD FOR ADJUSTING QUEUING DATA VOLUMN OF WIRELESS COMMUNICATIONS DEVICE BY DETECTING DATA TRANSFER SPEED AT PHYSICAL LAYER AND RELATED CONTROL MODULE AND MACHINE-READABLE MEDIUM THEREOF

(71) Applicants: Jen-Chieh Huang, New Taipei City (TW); Ying-Chieh Liao, Taipei City (TW); Yu-Ting Chen, Chiayi County (TW); Tsung-Chieh Chang, Taichung City (TW)

(72) Inventors: Jen-Chieh Huang, New Taipei City (TW); Ying-Chieh Liao, Taipei City (TW); Yu-Ting Chen, Chiayi County (TW); Tsung-Chieh Chang, Taichung City (TW)

(21) Appl. No.: 13/495,010

(22) Filed: Jun. 13, 2012

(51) Int. Cl. H04W 28/00

(52) U.S. Cl. 370/328

(57) ABSTRACT

A control method for a wireless communications device supporting a specific protocol includes detecting a data transfer speed at a physical layer of the wireless communications device regarding an architecture of the specific protocol, and accordingly generating a detection result; and adjusting queuing data volume of the wireless communications device according to the detection result. An associated control module for the wireless communications device is also provided. The associated control module includes a speed detection unit for performing the operation of detecting the data transfer speed at the physical layer of the wireless communications device, and a control unit for performing the operation of adjusting the queuing data volume of the wireless communications device.

### BACKGROUND

The disclosed embodiments of the present invention relate to enhancing transmission throughput, and more particularly, to a control method for a wireless communications device supporting a specific protocol, and a related control module and machine-readable medium thereof.

Performance of a wireless network is highly correlated with a modem's buffer size. If buffer size is too small, data transmission speed will be limited and the network will degrade granted resources; if the buffer size is too large, some data in the queue might not be transmitted before the transmission protocol (transfer control protocol (TCP), for example) times out, which leads to retransmission.

A traditional coping mechanism for this problem with regard to TCP is to dynamically change the packets window size in order to maximize transmission throughput, given the buffer size and network resources at the time. This method cannot deal with an internal delay of the modem, however.

There is a need, therefore, for an innovative control method and control module for a communications device supporting TCP to improve the overall performance of data transmission.

### SUMMARY

In accordance with exemplary embodiments of the present invention, a control method for a wireless communications device supporting a specific protocol, and a related control module and machine-readable medium thereof, are proposed to solve the above-mentioned problem.

According to a first aspect of the present invention, an exemplary control method for a wireless communications device supporting a specific protocol is disclosed. The control method includes detecting a data transfer speed at a physical layer of the wireless communications device regarding an architecture of the specific protocol, and accordingly generating a detection result; and adjusting queuing data volume of the wireless communications device according to the detection result.

According to a second aspect of the present invention, an exemplary control module for a wireless communications device supporting a specific protocol is disclosed. The control module includes a speed detection unit and a control unit. The speed detection unit is arranged for detecting a data transfer speed at a physical layer of the wireless communications device regarding an architecture of the specific protocol, and accordingly generating a detection result. The control unit is arranged for adjusting queuing data volume of the wireless communications device according to the detection result.

According to a third aspect of the present invention, an exemplary non-transitory machine-readable medium storing a program code is provided. When executed by a processor, the program code causes the processor to control a wireless communications device supporting a specific protocol by performing the following steps: detecting a data transfer speed at a physical layer of the wireless communications device regarding an architecture of the specific protocol, and accordingly generating a detection result; and adjusting queuing data volume of the wireless communications device according to the detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a control module for a wireless communications device supporting a specific protocol according to an embodiment of the present invention.

FIG. 2 is a block diagram illustrating a speed detection unit in FIG. 1 according to an embodiment of the present invention.

FIGS. 3A-3E are schematic diagrams respectively illustrating operations of the speed detection unit in FIG. 2 according to different exemplary designs of the present invention.

FIG. 4 is a block diagram illustrating the speed detection unit in FIG. 1 according to another embodiment of the present invention.

FIG. 5 is a block diagram illustrating a control module for a wireless communications device supporting a specific protocol according to another embodiment of the present invention.

FIG. 6 is a flowchart illustrating a control method for a wireless communications device supporting a specific protocol according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

A concept of the present invention is to minimize internal delay of a communications device, such as a network modem supporting transfer control protocol (TCP), in order to have a better overall transmission performance. Since the internal delay is greatly affected by a queuing scheme employed by the communications device, the communications device will dynamically adjust its transmission buffer size in order to control the volume of queuing data, thus minimizing the internal delay. Further details are described as follows.

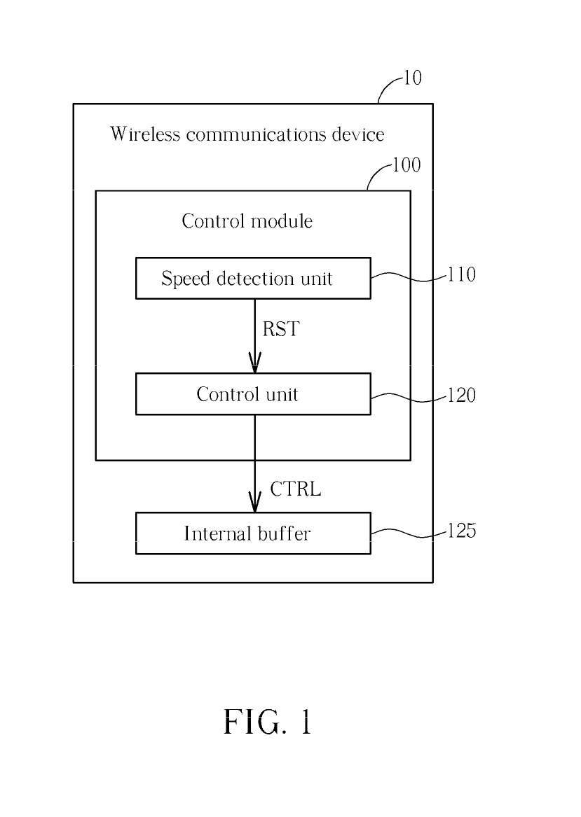

Please refer to FIG. 1, which is a block diagram illustrating a control module 100 for a wireless communications device 10 supporting a specific protocol according to an embodiment of the present invention. By way of example, but not limitation, the wireless communications device 10 may be a modem, and the specific protocol may be TCP. The control module 100 includes, but is not limited to, a speed detection unit 110 and a control unit 120. The speed detection unit 110 is arranged for detecting a data transfer speed at a physical layer of the wireless communications device 10 regarding an architecture of the specific protocol (the physical layer of TCP, for example), and accordingly generating a detection result RST. The control unit 120 is coupled to the speed detection unit 110 and an internal buffer 125, and arranged for adjusting queuing data volume of the wireless communications device 10 according to the detection result RST. Specifically, the control unit 120 generates a control signal CTRL to the internal buffer 125 for adjusting queuing data volume.

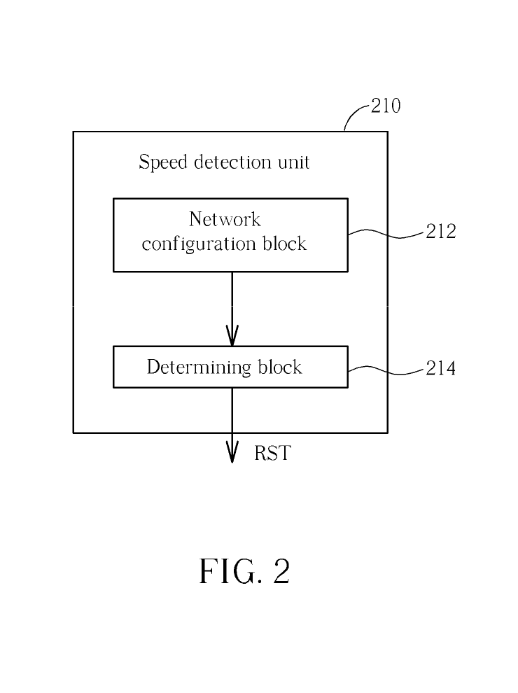

Please refer to FIG. 2, which is a block diagram illustrating the speed detection unit in FIG. 1 according to an embodiment of the present invention. The speed detection unit 110 may be realized by the speed detection unit 210. In this embodiment, the speed detection unit 210 includes, but is not limited to, a network configuration block 212 and a determining block 214. The network configuration block 212 is arranged for acquiring a network configuration designated by a wireless network with which the wireless communications device 10 communicates. For example, the wireless network may be a wideband code division multiple access (WCDMA) network. The determining block 214 is arranged for determining the data transfer speed according to the acquired network configurations, and accordingly generating the detection result RST.

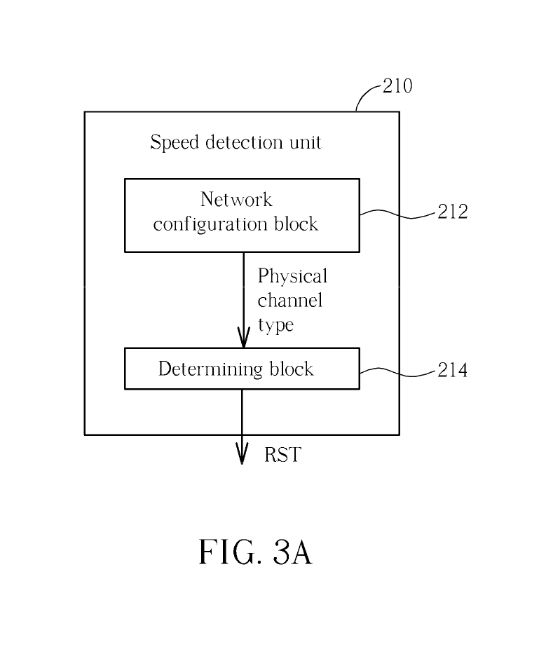

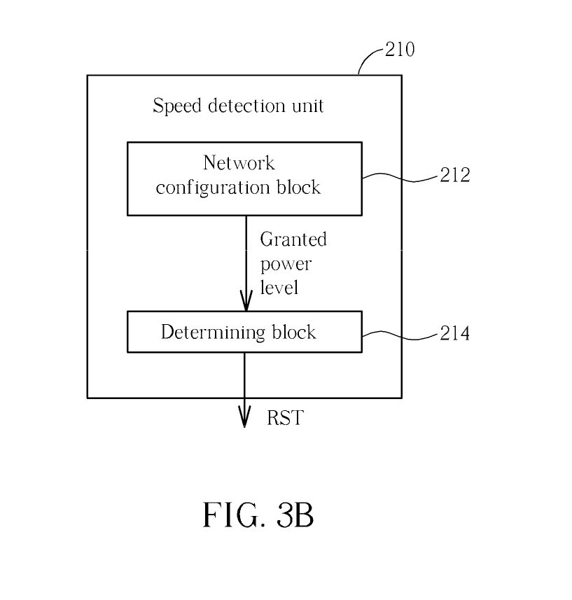

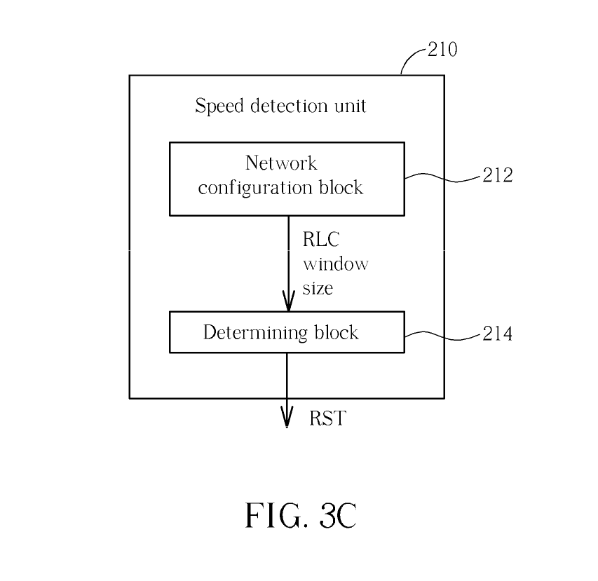

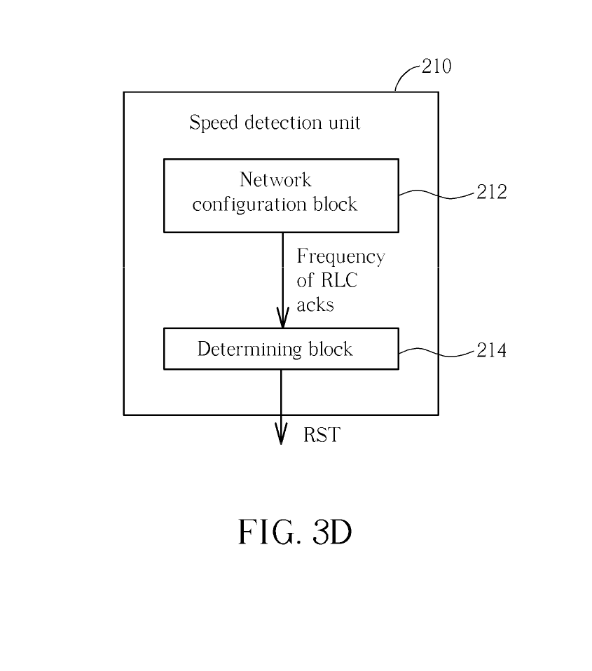

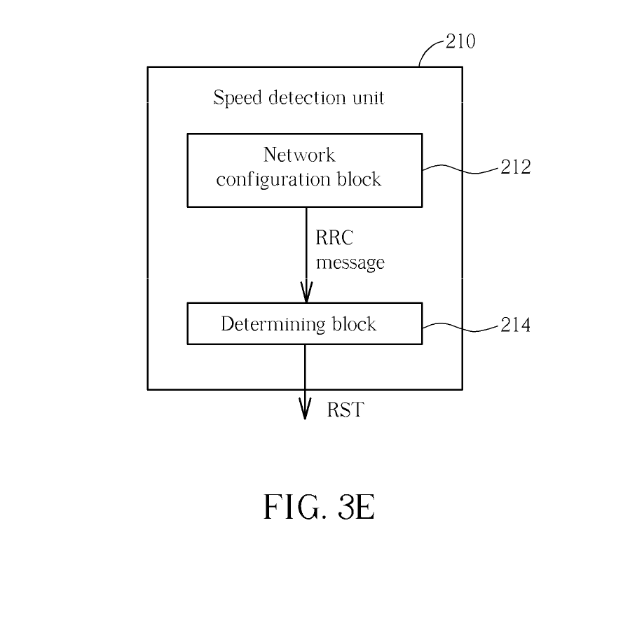

It should be noted that the network configuration is an instruction packaged in a control signal sent from a radio network controller (RNC) or a based station controller (BSC) of the wireless network to the control module 100 for controlling a transmission configuration of the wireless communications device 10. Please refer to FIG. 3A, which is a schematic diagram illustrating operations of the speed detection unit 210 in FIG. 2 according to a first exemplary design of the present invention. In the embodiment, the network configuration may be a physical channel type that the wireless communications device 10 is about to use (e.g. DCH or E-DCH in WCDMA network). Since the physical channel type is defined by mobile telecommunications specifications, the physical channel type should indicate a theoretical maximum transmission speed of the actual physical channel. Therefore, the determining block 214 can determine the data transfer speed by the theoretical maximum transmission speed of the physical channel type acquired by the network configuration block 212 and accordingly generate the detection result RST.

Please refer to FIG. 3B, which is a schematic diagram illustrating operations of the speed detection unit 210 in FIG. 2 according to a second exemplary design of the present invention. In this embodiment, the network configuration may be a transmission power level granted by the wireless network. In wireless communications, high transmission speed is often achieved via high-level modulation schemes (i.e. carrying more information on carrier waves) which may yield high error rate, and the high error rate may be mitigated by enhancing the transmission power level in order to elevate signal resolution. Therefore, the transmission power level granted by the wireless network can be an indicator for transmission speed. That is, the determining block 214 may determine the data transfer speed by the granted transmission power level and accordingly generate the detection result RST.

Please refer to FIG. 3C, which is a schematic diagram illustrating operations of the speed detection unit 210 in FIG. 2 according to a third exemplary design of the present invention. In this embodiment, the network configuration may be a radio link control (RLC) transmission window size. When the wireless network has more resources, the RLC transmission window size will grow larger and hence the transmission speed of the wireless network increases, and vice versa. As a result, the RLC transmission window size is usually a good indicator of the actual transmission speed of the wireless network at the time. Therefore, the determining block 214 may determine the data transfer speed by the RLC transmission window size and accordingly generate the detection result RST.

Please refer to FIG. 3D, which is a schematic diagram illustrating operations of the speed detection unit 210 in FIG. 2 according to a fourth exemplary design of the present invention. In this embodiment, the network configuration may be a frequency of RLC transmission acknowledgement messages. When the channel is heavily loaded or interfered, the frequency of RLC transmission acknowledgement messages will drop. If the channel is clear and transmission is good, the frequency of RLC transmission acknowledgement messages should reflect the exact speed of transmission. As a plurality of successfully transmitted data units require one acknowledgement message, the determining block 214 may determine the data transfer speed by referring to the frequency of RLC transmission acknowledgement messages, and accordingly generate the detection result RST.

Please refer to FIG. 3E, which is a schematic diagram illustrating operations of the speed detection unit 210 in FIG. 2 according to a fifth exemplary design of the present invention. In this embodiment, the network configuration may be a radio resource control (RRC) message. The RRC message may contain a transmission speed restriction to restrain the transmission speed at the physical level from exceeding a regulated value determined by the RRC protocol at the time. The determining block 214 may determine the data transfer speed by referring to the RRC message, and accordingly generate the detection result RST.

It should be noted that the above-mentioned exemplary designs are for illustrative purposes only, and are not meant to be limitations of the present invention.

Please refer to FIG. 1 again. In this embodiment, when the control unit 120 receives the detection result RST, the control unit 120 will send the control signal CTRL to an internal buffer 125 of the wireless communications device 10. The control unit 120 adjusts the queuing data volume of the wireless communications device 10 by adjusting a size of the internal buffer 125 of the wireless communications device 10. This is achieved by the control unit 120 decreasing the queuing data volume of the wireless communications device 10 when the detection result RST indicates that the data transfer speed decreases. For example, the control unit 120 decreases the queuing data volume of the wireless communications device 10 by decreasing the size of the internal buffer 125. The control unit 120 will increase the queuing data volume of the wireless communications device 10 when the detection result RST indicates that the data transfer speed increases. For example, the control unit 120 increases the queuing data volume of the wireless communications device 10 by increasing the size of the internal buffer 125.

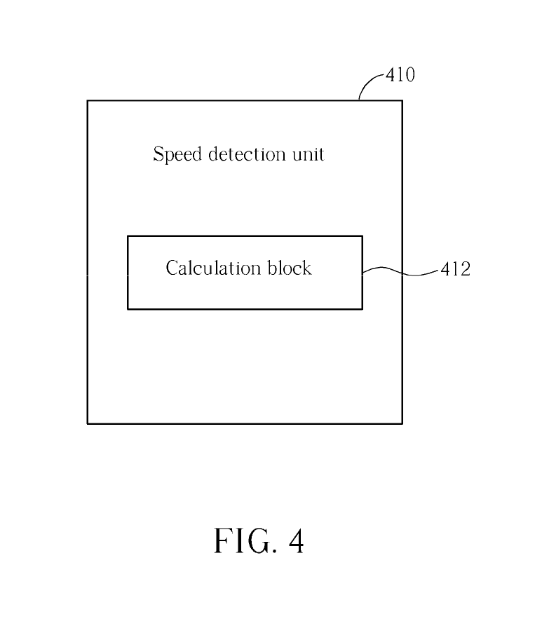

Please refer to FIG. 4, which is a block diagram illustrating a speed detection unit 410 according to another embodiment of the present invention. The speed detection unit 110 may be realized using the speed detection unit 410. The speed detection unit 410 includes, but is not limited to, a calculation block 412. The calculation block 412 is arranged for calculating an average transfer speed of an output of the wireless communications device 10. For example, the average transfer speed of the wireless communications device 10 may be a mean value of transfer speed observed over a period of time. The mean value may be calculated by employing a moving window, such as a ten-second window, to continuously average transferred data volume within the moving window, and average the averaged data volumes in order to obtain the average transfer speed. However, this is for illustrative purposes only and is not meant to be a limitation of the present invention. Those skilled in the art may employ one or more additional calculating technique (e.g., introducing a weighting system or filtering out singularities before the final averaging calculation) to obtain a more refined mean value without departing from the sprit of the present invention.

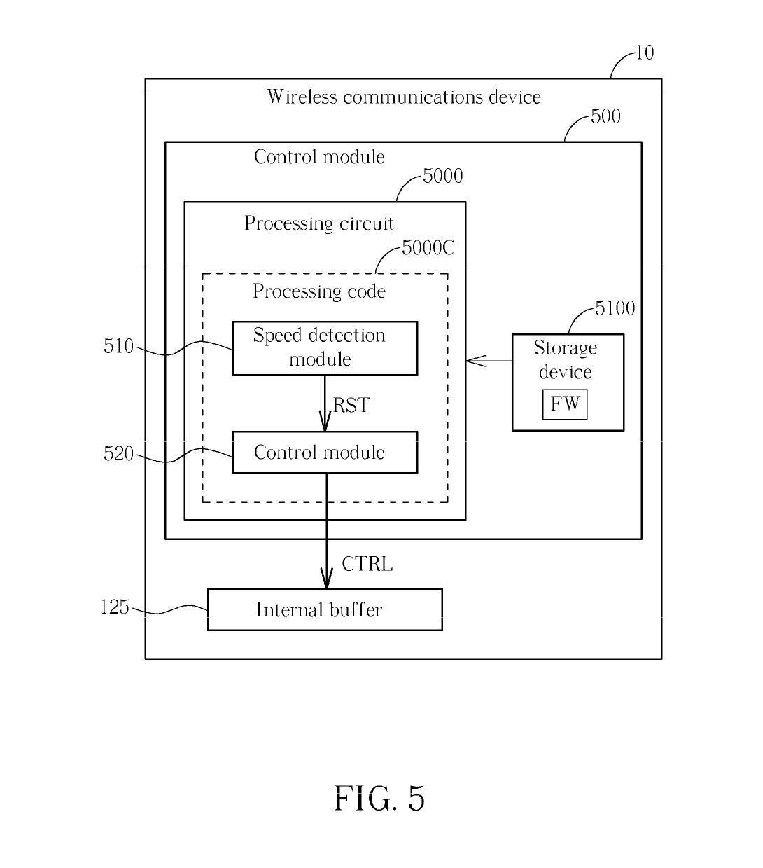

Please refer to FIG. 5, which is a block diagram illustrating a control module 500 for a wireless communications device 10 supporting a specific protocol according to another embodiment of the present invention. According to this embodiment, the control module shown in FIG. 1 can be implemented by utilizing a processing circuit 5000 executing a program code 5000C. It is labeled with the numeral 500 in this embodiment to reflect the change in architecture. For example, the processing circuit 5000 is a processor, and the program code 5000C may be firmware FW stored in a machine-readable medium such as a storage device (e.g. a non-volatile memory device) 5100. Hence, when loaded and executed by the processing circuit 5000, the program code 5000C causes the processing circuit 5000 to perform data transfer speed detection as well as queuing data volume adjustment. In addition, the program code 5000C may include at least one program module, such as a speed detection module 510 and a control module 520, where the speed detection module 510 can perform operations that are the same as or similar to those of the speed detection unit 110, and the control module 520 can perform operations that are the same as or similar to those of the control unit 120. As a person skilled in the art can readily understand operational details of the speed detection module 510 and the control module 520 after reading the above paragraphs, similar descriptions are not repeated for this embodiment shown in FIG. 5.

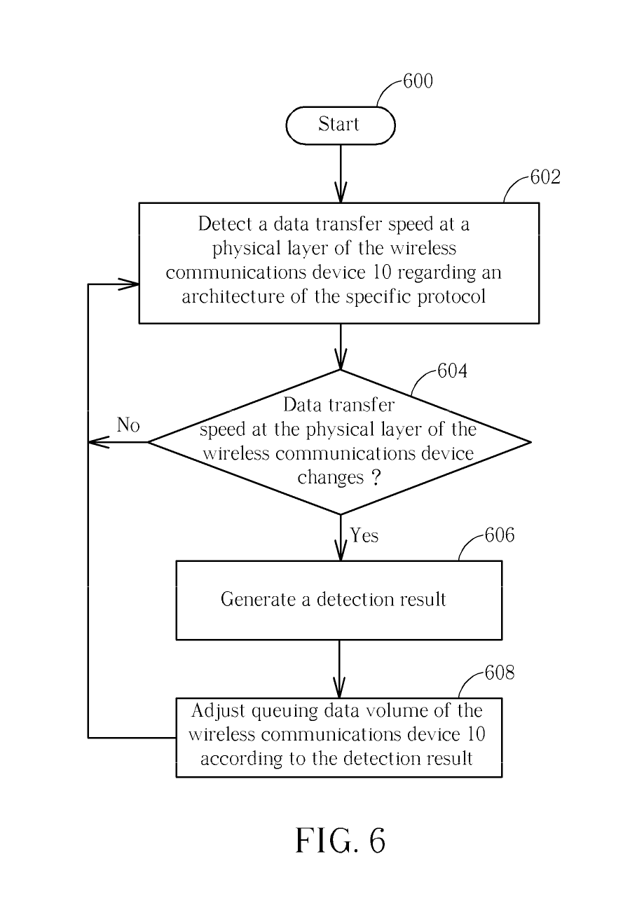

Please refer to FIG. 6, which is a flowchart illustrating a control method for a wireless communications device 10 supporting a specific protocol according to an embodiment of the present invention. Provided that the result is substantially the same, the steps are not required to be executed in the exact order shown in FIG. 6. The exemplary control method may be briefly summarized by the following steps.

Step 600: Start.

Step 602: Detect a data transfer speed at a physical layer of the wireless communications device 10 regarding an architecture of the specific protocol.

Step 604: Check if data transfer speed at the physical layer of the wireless communications device changes. If yes, go to step 606. Otherwise, go back to step 602.

Step 606: Generate a detection result.

Step 608: Adjust queuing data volume of the wireless communications device 10 according to the detection result. Go back to step 602 to keep monitoring the data transfer speed.

Step 602 and step 606 may be performed by the network configuration block 212 shown in FIG. 2 or the calculation block 412 in FIG. 4. Step 608 may be performed by the control unit 120 shown in FIG. 1. As a person skilled in the art can readily understand the operation of each step shown in FIG. 6 after reading the above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method for a wireless communications device supporting a specific protocol, comprising:
detecting a data transfer speed at a physical layer of the wireless communications device regarding an architecture of the specific protocol, and accordingly generating a detection result; and
adjusting queuing data volume of the wireless communications device according to the detection result.

2. The control method of claim 1, wherein the step of detecting the data transfer speed at the physical layer of the wireless communications device regarding the architecture of the specific protocol comprises:
acquiring a network configuration designated by a wireless network with which the wireless communications device communicates; and
determining the data transfer speed according to the acquired network configurations.

3. The control method of claim 2, wherein the network configuration comprises one or a combination of a portion/all of a physical channel type, a granted transmission power level, a radio link control (RLC) transmission window size, a frequency of radio link control (RLC) transmission acknowledgement messages, and a radio resource control (RRC) message.

4. The control method of claim 1, wherein the step of detecting the data transfer speed at the physical layer of the wireless communications device regarding the architecture of the specific protocol comprises:
calculating an average transfer speed of the wireless communications device.

5. The control method of claim 1, wherein the step of adjusting queuing data volume of the wireless communications device according to the detection result comprises:
decreasing the queuing data volume of the wireless communications device by decreasing an internal buffer size of the wireless communications device when the detection result indicates that the data transfer speed decreases.

6. The control method of claim 1, wherein the step of adjusting queuing data volume of the wireless communications device according to the detection result comprises:
increasing the queuing data volume of the wireless communications device by increasing an internal buffer size of the wireless communications device when the detection result indicates that the data transfer speed increases.

7. The control method of claim 1, wherein the specific protocol is a transmission control protocol (TCP).

8. A control module for a wireless communications device supporting a specific protocol, comprising:
a speed detection unit, for detecting a data transfer speed at a physical layer of the wireless communications device regarding an architecture of the specific protocol, and accordingly generating a detection result; and
a control unit, for adjusting queuing data volume of the wireless communications device according to the detection result.

9. The control module of claim 8, wherein the speed detection unit comprises:
a network configuration block, for acquiring a network configuration designated by a wireless network with which the wireless communications device communicates; and
a determining block, for determining the data transfer speed according to the acquired network configurations.

10. The control module of claim 9, wherein the network configuration comprises one or a combination of a portion/all of a physical channel type, a granted transmission power level, a radio link control (RLC) transmission window size, a frequency of radio link control (RLC) transmission acknowledgement messages, and a radio resource control (RRC) message.

11. The control module of claim 8, wherein the speed detection unit comprises:
a calculation block, for calculating an average transfer speed of the wireless communications device.

12. The control module of claim 8, wherein the control unit decreases the queuing data volume of the wireless communications device by decreasing an internal buffer size of the wireless communications device when the detection result indicates that the data transfer speed decreases.

13. The control module of claim 8, wherein the control unit increases the queuing data volume of the wireless communications device by increasing an internal buffer size of the wireless communications device when the detection result indicates that the data transfer speed increases.

14. A non-transitory machine-readable medium storing a program code that, when executed by a processor, causes the processor to perform the following steps to control a wireless communications device supporting a specific protocol:
detecting a data transfer speed at a physical layer of the wireless communications device regarding an architecture of the specific protocol, and accordingly generating a detection result; and
adjusting queuing data volume of the wireless communications device according to the detection result.

15. The non-transitory machine-readable medium of claim 14, wherein the step of detecting the data transfer speed at the physical layer of the wireless communications device regarding the architecture of the specific protocol comprises:
acquiring a network configuration designated by a wireless network with which the wireless communications device communicates; and
determining the data transfer speed according to the acquired network configurations.

16. The non-transitory machine-readable medium of claim 15, wherein the network configuration comprises one or a combination of a portion/all of a physical channel type, a granted transmission power level, a radio link control (RLC) transmission window size, a frequency of radio link control (RLC) transmission acknowledgement messages, and a radio resource control (RRC) message.

17. The non-transitory machine-readable medium of claim 14, wherein the step of detecting the data transfer speed at the physical layer of the wireless communications device regarding the architecture of the specific protocol comprises:
calculating an average transfer speed of the wireless communications device.

18. The non-transitory machine-readable medium of claim 14, wherein the step of adjusting queuing data volume of the wireless communications device according to the detection result comprises:
decreasing the queuing data volume of the wireless communications device by decreasing an internal buffer size of the wireless communications device when the detection result indicates that the data transfer speed decreases.

19. The non-transitory machine-readable medium of claim 14, wherein the step of adjusting queuing data volume of the wireless communications device according to the detection result comprises:
increasing the queuing data volume of the wireless communications device by increasing an internal buffer size of the wireless communications device when the detection result indicates that the data transfer speed increases.

20. The non-transitory machine-readable medium of claim 14, wherein the specific protocol is a transmission control protocol (TCP).
